(19) United States
(12) Patent Application Publication
(10) Pub. No.: US 2016/0368334 A1
(43) Pub. Date: Dec. 22, 2016

(54) TIRE TRACTION DEVICE

(71) Applicants: Brendan O'Connell, Encinitas, CA (US); William Schiefer, III, Carlsbad, CA (US); Nicole Delport, Encinitas, CA (US)

(72) Inventors: Brendan O'Connell, Encinitas, CA (US); William Schiefer, III, Carlsbad, CA (US); Nicole Delport, Encinitas, CA (US)

(21) Appl. No.: 14/745,219

(22) Filed: Jun. 19, 2015

(51) Int. Cl. B60C 27/20; B60C 27/02

(52) U.S. Cl. CPC B60C 27/20; B60C 27/0207; B60C 27/0276

(57) ABSTRACT

A traction device in a system comprises a tread member and a retaining member assembled to the tread member to form an interactive system. The retaining member holds the tread member in substantially complete surface contact with the tire tread in order to maintain a maximum coefficient of friction between a lower surface of the tread member and an outer surface of the tire tread. The retaining member comprises first and second ends comprising a hook and loop fastener system. The retaining member comprises a section for closely gripping tire sidewalls and a wheel. A hook and loop fastener is shaped to provide a locked assembly resistant to forces that would tend to disassemble the lock.

### CROSS-REFERENCE TO RELATED APPLICATIONS

This patent application claims priority from Provisional Patent Application Ser. No. 62/015,381 entitled TIRE TRACTION DEVICE, filed on Jun. 20, 2014. The contents of this provisional patent application are fully incorporated herein by reference.

### FIELD

The present subject matter relates to wheels for land vehicles, and more particularly to devices for increasing traction having a traction member removably secured to a tire tread.

### BACKGROUND

In climates in which roads become covered with snow, the use of traction-increasing devices may be essential for maintaining sufficient traction to allow a vehicle to move in the snow. Traction-increasing devices may aid in decelerating a vehicle in order to avoid collisions or running off the road.

An early form of a traction device was tire chains. This device was and still is inconvenient to install. Tire chains damage road surfaces. A next generation of traction devices comprised studded tires. Studs comprising small cylindrical bodies projected radially from a tire tread. Carbide or other strong materials have been used to make the studs. Carbide is harder than concrete or asphalt road surfaces. Due to destructive effects of traction-increasing devices on road surfaces, many jurisdictions have banned the use of devices such as studs.

In response, the industry has provided devices which may be removably attached to a tire. A device may comprise a traction member held against a tire's outer diameter. A significant problem is providing a convenient and reliable means for supporting the traction member in engagement with the tire. Prior devices have each presented different drawbacks.

U.S. Pat. No. 7,426,949 discloses a traction device for maintaining a bar against a tire. A first end of a radially extending support member is bolted to a wheel. A second end of the support member projects radially from the first support member past the tire tread. A traction bar is cantilevered from the second end of the support member in an axial direction and rests against the tire. This structure requires a specially made wheel to cooperate with the support member. It is not suitable for use with conventional wheels. The cantilevered mounting can have limited reliability.

U.S. Patent Application Publication Number 2009/00396 discloses a releasably attached traction device. The traction device has a first end hooked into an eye of a first fixing device. A second end has a second fixing device. The traction device extends around the tire to a point radially inward and goes around the wheel. The second fixing device interlocks with the first fixing device. The first and second fixing devices comprise a complex mechanism which can become ice bound. This can prevent removal of the device. If ice forms in the fixing members prior to attachment, it may be impossible to install the device when needed.

U.S. Pat. No. 3,937,262 discloses a traction device in which an arcuate segment of a larger tire is placed over a smaller tire. The segment is secured to the tire by radially extending studs. The device may be for attachment to one or both of the rear wheels of a vehicle. This device does not comprise a fully interactive traction system. Reliability is not assured.

U.S. Pat. No. 4,747,438 discloses a traction device in which radially extending arms are secured to a wheel. Each arm receives a traction device. The traction device is J-shaped. The long arm of the J is received in a radially extending arm. The remainder of the J shape extends across the tire tread and hooks onto an inner side of the tire. This is a complex construction designed to poke into sand and earth as well as snow. The rigid components do not allow for close interfacing of the traction device and a tire. Radially extending cleats are not suited for continued traversing of highways. A rough ride is provided and highway damage is produced.

### SUMMARY

Briefly stated, in accordance with the present subject matter, an apparatus and method are provided in which a traction device comprises a tread member and a retaining member. The retaining member is assembled to the tread member. The tread member is maintained in a manner to resist forces on a fastening area over a radially extending portion of a tire. The tread member and the retaining member form an interactive system. The retaining member holds the tread member in substantially complete surface contact with the tire tread in order to maintain a maximum coefficient of friction between a lower surface of the tread member and an outer surface of the tire tread. The material of the tread member is selected to satisfy many needs. It must be elastomeric so as to conform to the tire but must also be composed to withstand the forces applied to between the road and the tire. The tread member and the retaining member comprise an assembly. When one member wears out, it is not necessary to discard the other. The retaining member is also constructed to meet a number of needs. The retaining member must be sufficiently flexible to be able to go around an irregular perimeter comprising an outer tire sidewall, tire tread, inner tire sidewall, and portions of the wheel radially inwardly of the tire. In accordance with the present subject matter, flexible reusable fastening means are provided. A hook and loop fastener is utilized in a manner to provide convenience in assembly and disassembly while being formed to comprise a lock assembly resistant to forces that would tend to disassemble the lock.

### BRIEF DESCRIPTION OF THE DRAWINGS

FIG. 1 is a perspective view of a traction device system comprising a plurality of traction devices mounted to a tire;

FIG. 2 is an elevation of the tire and system of FIG. 1;

FIG. 3 is a plan view of a tread member;

FIG. 4 is a side elevation of the tread member;

FIG. 5 is a front elevation of the tread member;

FIG. 6 is a bottom plan view of the tread member;

FIG. 7 is a perspective view of alignment of a retaining member and a tread member prior to assembly;

FIG. 8 is an illustration of the retaining member;

FIG. 9 is a partial detailed front elevation showing a retaining member assembled to a tread member;

FIG. 10 is a perspective view of a traction device showing opposite ends of the retaining member aligned for engagement;

FIG. 11 is a perspective view of a traction device showing opposite ends of the retaining member fastened to one another;

FIG. 12 is a cross-section taken across lines 12-12 of FIG. 2

FIG. 13 is a partial detailed view of FIG. 12; and

FIG. 14 is a diagram illustrating responses of the retaining member to outside forces.

### DETAILED DESCRIPTION

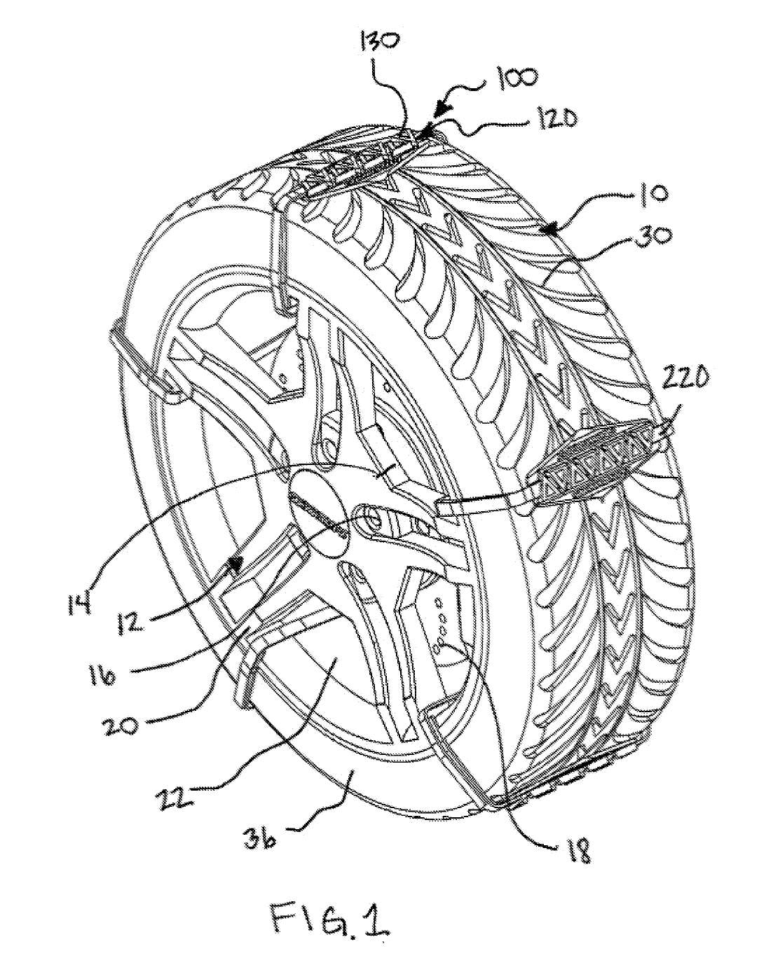

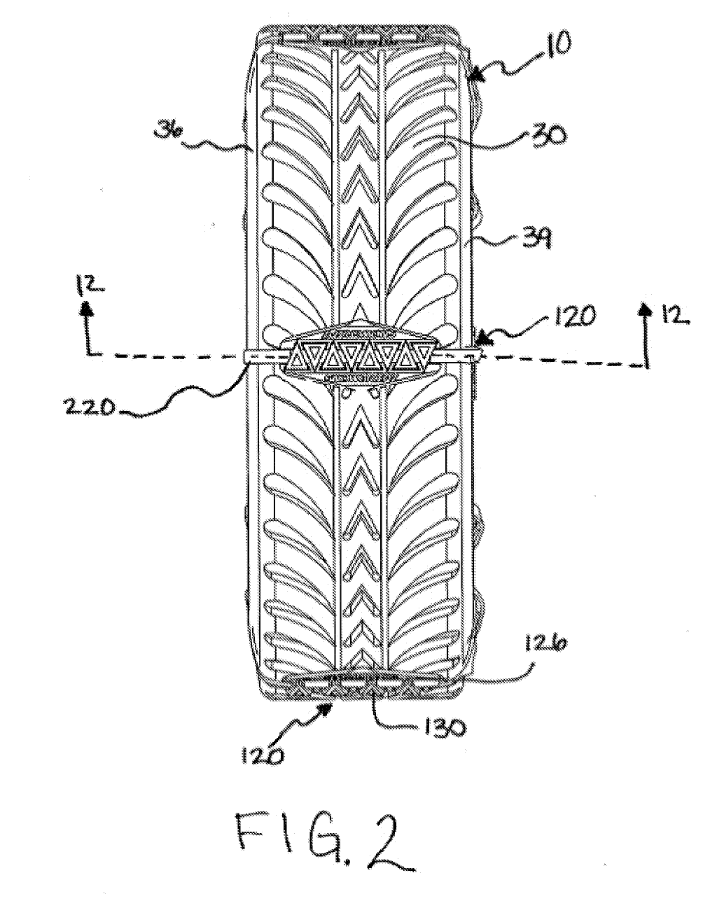

FIG. 1 is a perspective view of a traction device system comprising a plurality of traction devices mounted to a tire. FIG. 2 is an elevation of the tire and system of FIG. 1. FIGS. 1 and 2 taken together illustrate the spatial relationship which yields the interactivity of the tire 10, wheel 12, and the traction device system 100. In each of the figures, the same reference numerals are used to denote the same elements. A tire 10 is mounted on a wheel 12 mounted for rotation by an axle 14. Lug nuts 16 retain the wheel 12 to the axle 14. In the present illustration, the wheel 12 surrounds a disc brake assembly 18. The wheel 12 comprises a rim 20. The rim 20 retains edges of the tire 10 at an annular inner rim portion 24 (FIG. 12). The wheel 12 has axially extended open areas 22 through which securing means may pass. The tire 10 has a tread 30 axially extending around an outer diameter of the tire 10. An outer sidewall 36 and an inner sidewall 39 (FIG. 2) of the tire can extend from the outer diameter to a bead 38 (FIG. 12) which is received in the rim 20 at an inner diameter of the tire 10.

A traction device system 100 comprises a plurality of traction devices 120. Each traction device 120 comprises a tread member 130 extending axially across the entire tread 30 at a selected angular position. A retaining member 220, further described beginning at FIG. 7 retains the tread member 130 to the tire 10. A number of traction devices 120 are provided spaced around the tire tread 30. The number of traction devices 120 utilized represents an optimization of complexity of the traction device system 100 and level of effort required to mount the traction device system 100 versus the amount of traction that is provided. In the present illustration, five traction devices 120 are provided, each angularly spaced from a next traction device 120 by 72°. It is desirable to have at least one traction device 120 in contact with the road at all times. Five traction devices 120 will generally be sufficient for mounting on 14 inch to 18 inch wheels. Tires for large trucks will normally require a greater number of traction devices 120.

FIG. 2 illustrates the interaction of the traction devices 120 with the surface of the tire tread 30. In accordance with one aspect of the present subject matter, gaps between the surface of the traction device 120 and the tread 30 are minimized. This is illustrated particularly at an interface 126.

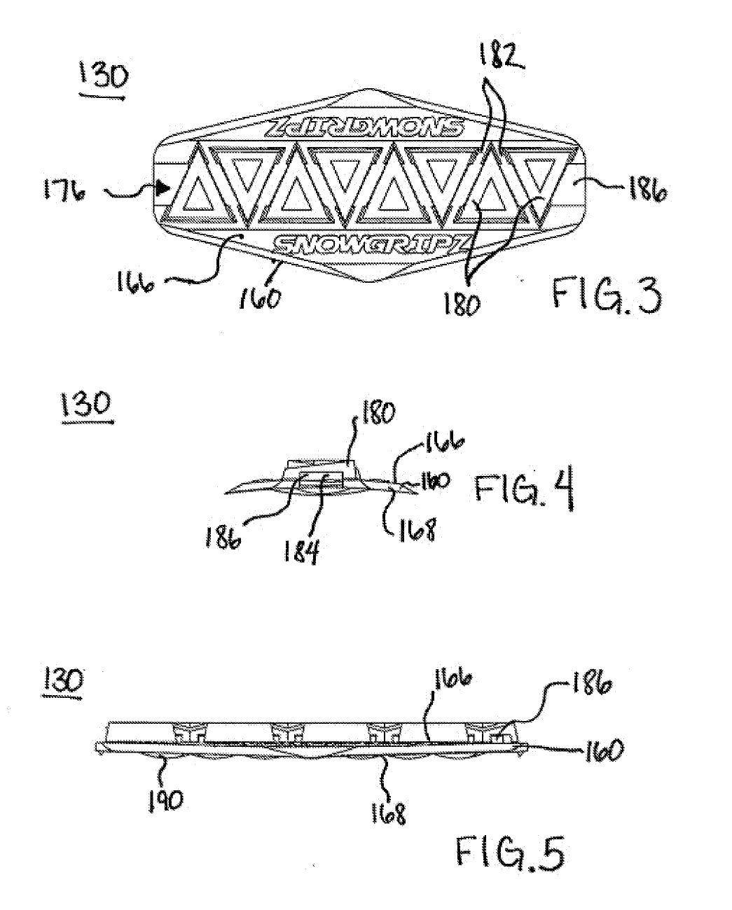

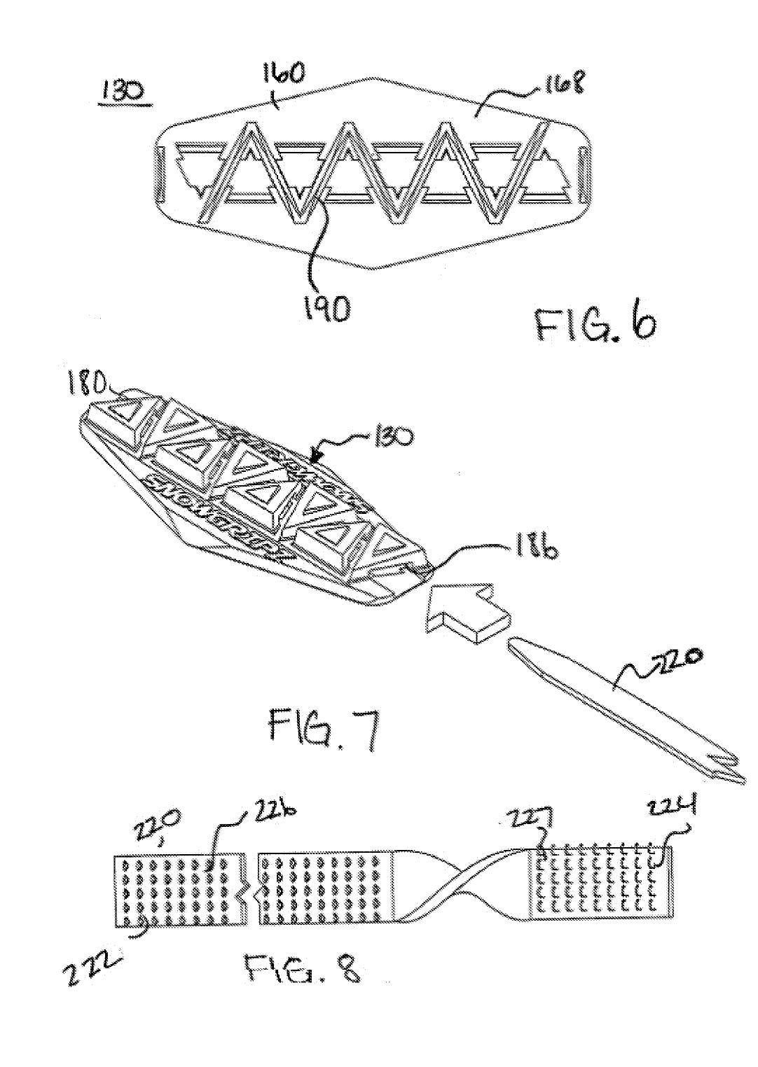

FIGS. 3, 4, 5, and 6 taken together illustrate a tread member 130. FIG. 3 is a plan view of a tread member 130, FIG. 4 is a side elevation of the tread member 130, FIG. 5 is a front elevation of the tread member 130, and FIG. 6 is a bottom plan view of the tread member 130.

The material selected is one that remains pliable in subfreezing operating temperatures. One preferred material for the tread member 130 is ethylene-vinyl acetate (EVA), also known as poly(ethylene-vinyl acetate) (PEVA). EVA is the copolymer of ethylene and vinyl acetate. The weight percent vinyl acetate usually varies from 10% to 40%, with the remainder being ethylene. EVA has properties approximating softness and flexibility of elastomers. Other advantages of EVA are the ability to use general thermoplastic processing techniques, stress-crack resistance, resistance to brittleness at low temperatures, and resistance to UV radiation. A high durometer elastomer is an alternative.

The tread member 130 is shaped to interlock with the tread 30 of the tire 10 (FIG. 1) and have a surface in contact with the tread 30. The tread member 130 comprises a central support member 160. The central support member 160 has an upper surface 166 and a lower surface 168 (FIG. 6). In one preferred form, the central support member 160 has a rectangular cross-section in a radial degree of freedom. The central support member 160 is disposed straight across the tire tread 30. The central support member 160 has a curved cross-section in an axial degree of freedom, i.e., the central support member 160 may be curved to approximate the curvature of the outer diameter of the tire 10.

An axial row 176 of teeth 180 (FIG. 4) extends radially outwardly from the central support member 160. The teeth 180 are each shaped to grip a snowy road surface and to define channels 182 from which snow and mud may be expelled as the tire 10 rotates. The teeth 180 have axially aligned apertures 184, preferably disposed radially in the vicinity of the central support member 160. The aligned apertures 184 collectively form a channel 186. A retaining member 220 (FIG. 7), further described below, is threaded through the apertures 184 to provide for holding the tread member 130 against the tire tread 30 (FIG. 2) when the traction device 120 is fastened to the tire tread 30.

A plurality of cleats 190 (FIG. 6) are formed projecting radially inwardly from the lower surface 168 of the central support member 160. The cleats 190 are positioned to engage recesses in the tire tread 30. The cleats 190 may be arranged to mesh with the tread pattern of a specific tire 10. Alternatively, the cleats may be arranged in an order that will provide a less precise fit across a wider range of tread patterns.

FIG. 7 is a perspective view of alignment of a retaining member 220 and a tread member 130 prior to assembly. A user will generally thread the retaining member 220 through the channel 186 prior to placing the tread member 130 on the tire tread 30. The width of the retaining member 220 is preferably dimensioned to have a small clearance with the channel 186. A preferable clearance is ±0.01 inches for the height (radial) dimension and ±0.06 inches for the width. It is desirable to minimize possible movement of the retaining member 220 with respect to the tread member 130.

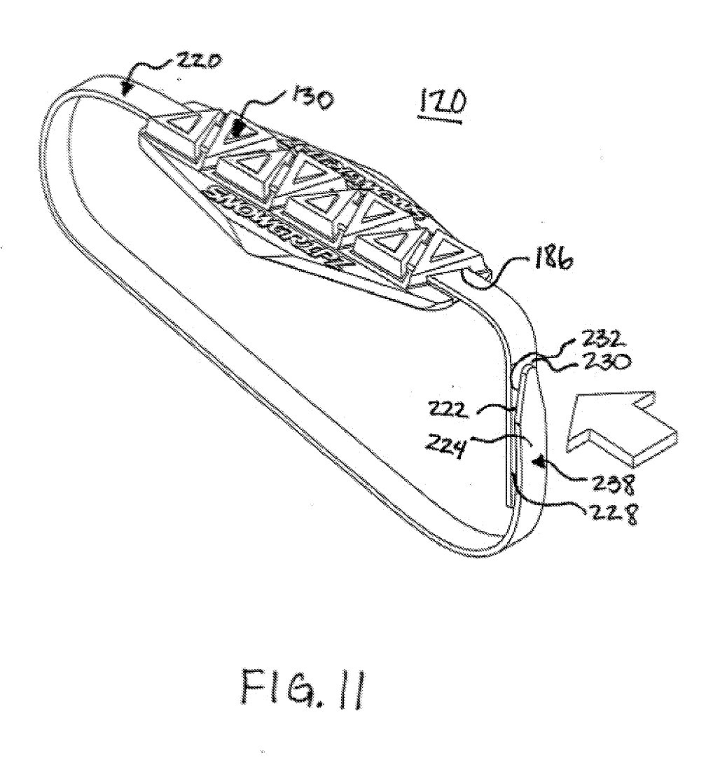

FIG. 8 is an illustration of the retaining member 220. Opposite end sections 222 and 224 of the retaining member 220, or tip and tail sections, comprise a fastening means 228 (FIG. 10). The fastening means 228 comprises a hook and loop fastener. Hook and loop fasteners are often referred to by the trademark Velcro®. The retaining member 220 may be provided to a user in a length exceeding many foreseeable applications. The user may then install the traction device 120 and cut off excess length of the retaining member 220. End sections 222 and 224 may be defined by their overlapping areas when installed.

Various forms of hook and loop fasteners are available in different levels of size and sturdiness. Weaker fasteners may be used to retain traction devices 120 on a tire, with maximum speed allowable being determined by trial and error. However, it is preferable to provide reliable fastening for highway speeds. One form of fastener suitable for normal driving applications is “military grade” hook and loop fastener material. For purposes of the present specification, “military grade” means a suitable material defined by GSA standard A-A-55126B promulgated by the United States General Services Administration, Sep. 7, 2006. A reliable form of fastener comprises a hook portion made up of 75% aramid and 25% nylon with a loop portion made up of 100% aramid. Less expensive materials may be used providing that a manufacturer has tested them. It is desirable to use materials with higher density for mechanical adhesion. It is also desirable to provide a high level tear point.

In a preferred form, the entire retaining member 220 comprises a hook and loop fastener having a hook surface 226 and a loop surface 227. It is preferable to have the loop surface 227 facing outwardly from the tire and engaging a road surface.

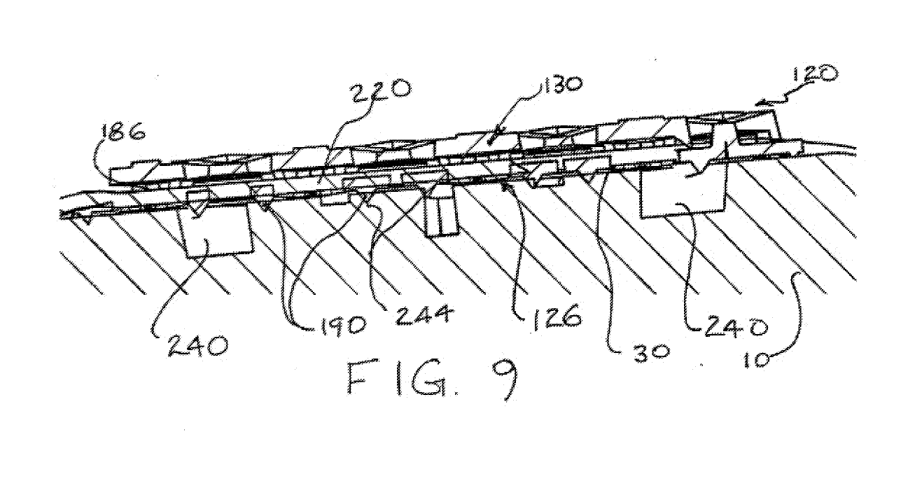

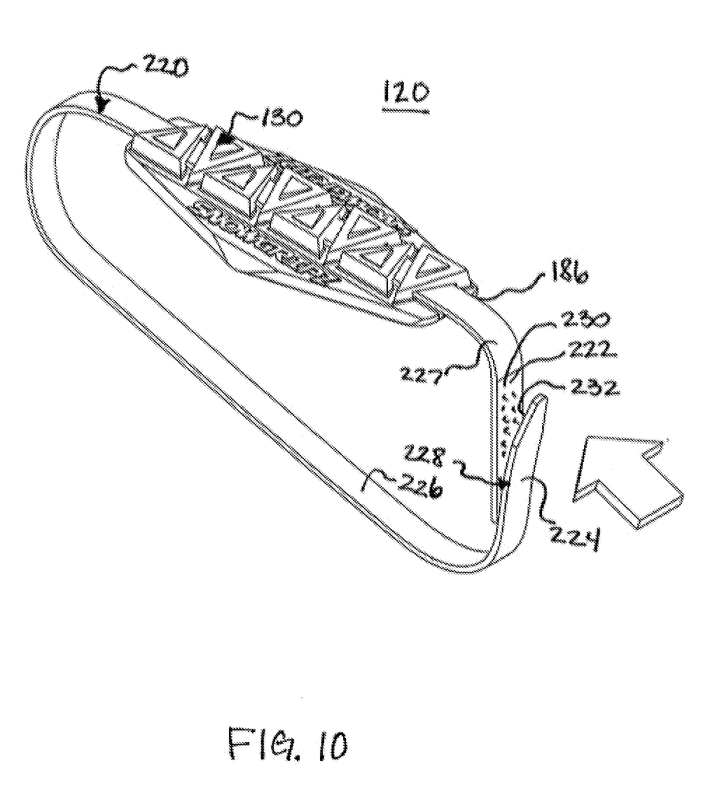

FIG. 9 is a side elevation in cross-section showing a retaining member 220 assembled to a tread member 130. The retaining member 220 projects through the channel 186. The retaining member 220 retains the tread member 130 against the tread 30. This is illustrated in a complete system below in FIG. 12. The engagement of the cleats 190 with the tread 30 occurs at the interface 126. The cleats 190 may fit into open areas 240 of the tread 10 or may press into flat surfaces of the tread 10 at points 244 in registration with other cleats 190.

FIG. 10 is a view of a traction device 120 showing opposite ends of the retaining member aligned for engagement. A first end section 222 is disposed with a loop field 230 facing radially outwardly from the tire 10. The second end section 224 contains a hook field 232. Opposite end sections 222 and 224 of the retaining member 220 comprise the fastening means 228.

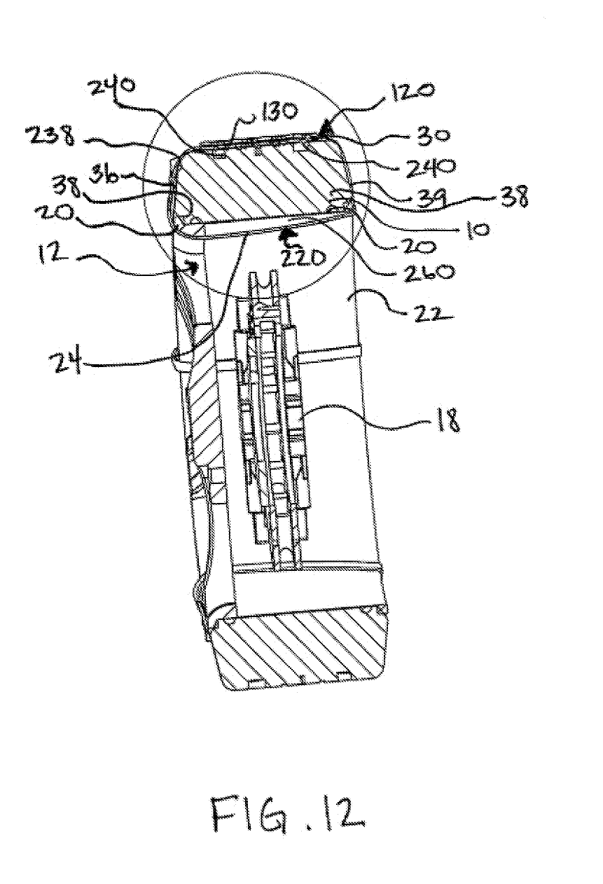

FIG. 11 is a perspective view of a traction device showing opposite first end section 222 and second end section 224 of the retaining member 220 fastened to one another. The fastened ends comprise a lock assembly 238. The lock assembly 238 comprises the completely mating portions of the hook and loop fastening means 228. The loop field 230 and the hook field 232 are covered. They are largely protected from snow and mud. They also provide a solid assembly so that the traction device 120 will remain fastened to the tire 10 even if a driver might brush a curb. The upward facing end of the retaining member 220 should be on the outside of the lock assembly 238.

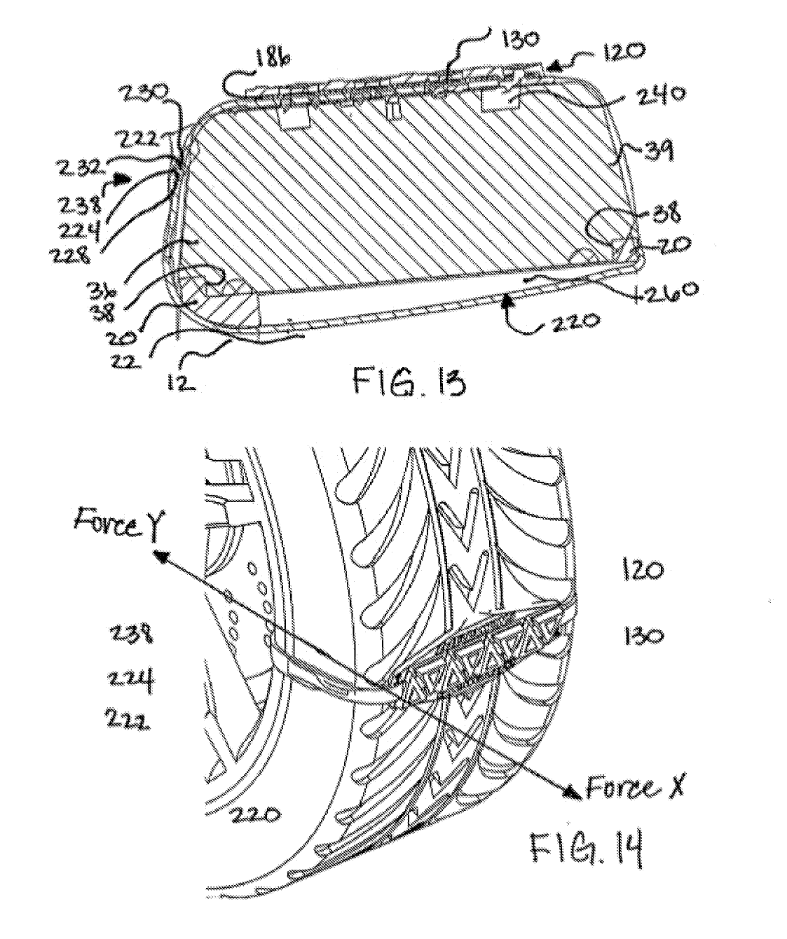

FIG. 12 is a cross-section taken across lines 12-12 of FIG. 2, and FIG. 13 is a partial detailed view of FIG. 12. In order to mount the traction devices 120 across the tire 10, the retaining member 220 is threaded through the tread member 130. A first end section 222 of the retaining member 220 is held against outer sidewall 36 of the tire 10. The retaining member is threaded through the tread member 130 and extends around the tire 10 across an inner sidewall 39 and through one open area 22 and brought back around to be in alignment with the first end section 222. The ends are pressed together to form the lock assembly 238.

The occurrence of gaps between the retaining member 220 and surfaces of the wheel 12 are more easily seen in FIG. 13. The retaining member 220 may bear against a rim 20 at an inner side of the wheel 12 and extend across a portion of the wheel adjacent the outer side of the wheel 12. Since the outer side of the wheel 12 may have a different inner diameter from the inner diameter on the inner side of the wheel 12, a gap 260 will be present. The retaining member 220 will be subject to flexion and extension in the portion extending across the gap 260.

FIG. 14 is a diagram illustrating responses of the retaining member to outside forces at the lock assembly 238. Force x represents forces applied from engagement of the traction device 120 with the road. Force y represents the reaction force exerted by the hook and loop lock assembly 238. Both forces x and y react in a radial direction. This is a direction in which strength of the hook and loop fastening is maximized. Unfastening of a hook and loop joint generally requires forces that provide a resultant at an angle to the radial direction.

As a car sits in a stationary position, the retaining member 220 retains the tread member 130. The first end section 222 (FIG. 11) is overlapped by the second end section 224 on the outside. The lock assembly 238 gains centrifugal force from radial acceleration. The lock assembly 238 bears against the outer sidewall 36 of the tire 10 in a radial direction, maximizing the overlapping bond of the hook and loop system.

As the car accelerates the outside or tip of the fastener will gain centrifugal force, that will increase its bond with the tail of the fastener, because of the orientation of these tip and tail ends of the retaining member 220. The tail end 224 must be oriented on the outside of the tail in order to take advantage of centrifugal forces that will improve its mechanical bond.

Centrifugal force is an outward force apparent in a rotating reference frame; it does not exist when measurements are made in an inertial frame of reference. This type of force, associated with describing motion in a non-inertial reference frame is referred to as a fictitious or inertial force; a description that must be understood as a technical usage of these words that means only that the force is not present in a stationary or inertial frame.

In a rotating reference frame, all objects appear to be under the influence of a radially outward force that is proportional to their mass, the distance from the axis of rotation of the frame, and to the square of the angular velocity of the frame. The center of rotating reference is the center of the vehicle tire.

Motion relative to a rotating frame results in another fictitious force, the Coriolis force; and if the rate of rotation of the frame is changing, a third fictitious force, the Euler force is experienced. Together, these three fictitious forces are necessary for the formulation of correct equations of motion in a rotating reference frame.

The present subject matter provides for many advantages. The hook and loop fastening system along with the novel retaining member provide for strong and reliable fastening. The present retaining members are superior to zip ties in that they provide for selectable characteristics such as resiliency, resistance to brittleness, less breakage, and being proportional to the retaining channel in the tread member in order to provide options in modes of assembly and in engagement of the tread member to a tire. Modularity of the tread member and the retaining member provides for selection of cooperative characteristics. For example, a tread member designed for maximum hardness may require a retaining member with additional resiliency. Retaining members may also be designed as custom matches for selected wheels.

While the foregoing written description of the present subject matter enables one of ordinary skill to make and use what is considered presently to be the best mode thereof, those of ordinary skill will understand and appreciate the existence of variations, combinations, and equivalents of the specific embodiment, method, and examples herein. The present subject matter should therefore not be limited by the above described embodiment, method, and examples, but by all embodiments and methods within the scope and spirit of the present subject matter.

What is claimed is:

1. A traction device system comprising at least one traction device, the traction device comprising:
a tread member having a central support member, the support member having tread teeth projecting from an upper surface thereof, the tread teeth having an aligned series of apertures comprising a channel for receiving retaining means, the central support member further comprising radially inwardly projecting cleats; and
a retaining member for threading through the aligned series of apertures, the retaining member having a first end section and a second end section comprising locking portions and wherein a hook and loop fastener comprises the locking portions and wherein the locking portions when engaged comprise a lock assembly.

2. A traction device system according to claim 1 wherein said central support member has a rectangular cross-section in a radial degree of freedom and wherein the central support member has a curved cross-section in an axial degree of freedom.

3. A traction device system according to claim 2 wherein said retainer comprises a hook and mesh fastener along its entire length.

4. A traction device system according to claim 1 wherein said retaining member comprises a hook and loop fastener having a density and hook and loop sizes selected to correlate with a preselected speed level up to which the lock assembly will remain locked.

5. A method of providing increased traction comprising:
providing a retaining member having a tip end and a tail end;
threading the retaining member through a channel in the tread member;
disposing the retaining member around a tire and a wheel rim to maintain the tread member against a tire tread;
forming a hook and loop joint adjacent a tire sidewall; and
disposing the joint in a radial direction against a sidewall of the tire.

6. A method according to claim 5 wherein the step of forming the hook and loop joint comprises placing the tail end against a tire sidewall, extending the retaining member in a radial direction away from a wheel axle, wrapping the retaining member around a tire and a wheel, and engaging the tip end with the tail end, the tip end being placed on an outside of the tail end.

7. A method according to claim 6 wherein a loop surface is on a radially disposed outside of the retaining means.

8. A method according to claim 7 comprising providing a retaining member having a length longer than a perimeter around the tire and wheel and removing excess length from the retaining member after forming a lock assembly.
